(19) United States
(12) Patent Application Publication
(10) Pub. No.: US 2011/0239012 A1
(43) Pub. Date: Sep. 29, 2011

(54) IMAGE PROCESSING DEVICE

(75) Inventors: Nobuaki KOHINATA, Yokohama (JP); Jun Sato, Kanagawa (JP); Yoshihiro Saito, Kanagawa (JP); Nobuhiro Yokoi, Fujisawa (JP)

(73) Assignee: RENESAS ELECTRONICS CORPORATION

(21) Appl. No.: 13/070,843

(22) Filed: Mar. 24, 2011

(30) Foreign Application Priority Data
Mar. 24, 2010 (JP) 2010-067764

(51) Int. Cl. G06F 1/32

(52) U.S. Cl. 713/310

(57) ABSTRACT

The image processing device involves a power-saving condition, which achieves the reduction in power consumption on standby, and the high-speed recovery from its power-saving condition to the normal condition. The image processing device has: a data processing unit which executes the processing of stream data; a communication-processing section which accepts input of a processing request from the data processing unit, and controls the data processing unit; and a nonvolatile memory unit which stores control information involved with data processing. The data processing unit has a power-saving mode in which no power source is supplied, and a normal operation mode in which the power source is supplied. In the power-saving operation mode, the communication-processing section causes the data processing unit to transition to the normal operation mode when detecting a processing request for data processing. Then, the data processing unit acquires control information from the nonvolatile memory, and executes data processing.

### CROSS-REFERENCE TO RELATED APPLICATIONS

The Present application claims priority from Japanese application JP 2010-067764 filed on Mar. 24, 2010, the content of which is hereby incorporated by reference into this application.

### BACKGROUND

The present invention relates to an image processing device, and particularly to a technique useful in application to an image processing device which executes data processing of stream data.

In recent years, image processing devices for STB (Set Top Box) and IPTV (Internet Protocol Television), which receive video and audio contents through a network, reproduce the contents, and store the contents in storage devices, are becoming ubiquitous as the speed of networks increases. Reflecting growing concern about protection of the global environment of recent years, such image processing devices are required to achieve the reduction in power consumption on standby, and to have a mechanism capable of immediately responding a request for diagnosis and a request for processing from other data and image processing devices connected therewith through a network even on standby.

Japanese Unexamined Patent Publication No. 2009-134696 discloses, as a prior art, a data processing device which achieves the reduction in power consumption while keeping a connection to a network. The data processing device is arranged to be switchable between a normal condition, i.e. a normal power mode, and a power-saving condition, i e. a power-saving mode. In the power-saving condition, the data processing device supplies electric power to a connection unit for communication through a network and to a packet-processing unit for performing analysis of received packet data and the like without providing power to a processor in charge of processing packet data, whereby reducing the power consumption. Further, the data processing device in the power-saving condition goes into the normal condition on receipt of packet data through network, which needs data processing by the processor.

### SUMMARY

The data processing device as disclosed by Japanese Unexamined Patent Publication No. 2009-134696 chiefly handles packet data which has a short data length and which doesn't need to go through real-time processing (hereinafter referred to as “non-stream data”) . Further, adopted as the protocol that the data processing device uses in communication is a protocol such that a request for retransmission can be issued even in the event of failure in reception of non-stream data, for example. Therefore, the probability that the recovery of the data processing device from the power-saving condition to the normal condition affects a user using the data processing device is slim even in the case where a strict procedure designed for the recovery in consideration of time is not established. In contrast, the forementioned image processing device chiefly handles successive packet data of e.g. video and music contents having a long data length (hereinafter referred to as “stream data”), and receives a certain amount of data at intervals over time. Further, a protocol such that retransmission is not requested even with a failure in reception of data is adopted for the image processing device. Therefore, for arranging the image processing device to switchable between the normal condition and power-saving condition, a recovery procedure designed in consideration of time for the image processing device to recover from the power-saving condition to the normal condition, and a recovery means for executing the recovery procedure become necessary. For example, a buffer to temporarily store stream data in during the time between the transition from the power-saving condition to the normal condition and the start the video processing including e.g. recording and reproduction of an image becomes necessary for the image processing device to receive stream data through a network, transition from the power-saving condition to the normal condition, and then start the video processing. In this case, the following two points become problems. The first is that in the case of an image processing device such that what processing procedure to follow must be decided on an as-needed basis before starting processing in response to a command involved in video processing, it takes time to execute a step of establishing a processing procedure each time a command is issued, and then preparing control information which specifies the processing procedure thus established, which leads to a delay in the time of starting the video processing. As a result of this, the responsiveness worsens, which can cause the deterioration of convenience, and therefore cause a user using the image processing device to feel discomfort. The second is that the amount of stream data which need to be stored increases as the elapsed time between the transition to the normal condition and the start of processing becomes longer, and therefore the capacity of a buffer must be increased to prevent the overflow of the buffer from deteriorating the data quality. Particularly, taking into account the speedup of networks and the increase in data amount resulting from the rise in definition of video images in recent years, it is necessary to make larger the capacity of a buffer, which leads to the increase of the cost of parts or components of an image processing device.

This being the case, it is an object of the invention to provide an image processing device having a power-saving mode which enables the reduction of power consumption in the standby condition, and which enables high-speed recovery from the power-saving mode to the normal condition.

The above and other objects of the invention and novel features thereof will be apparent from the description hereof and the accompanying drawings.

Of the embodiments herein disclosed, a representative embodiment will be outlined below.

An image processing device according to the representative embodiment of the invention has: a data processing unit operable to execute data processing of stream data; a communication-processing section which accepts input of a processing request for data processing from the data processing unit, and controls the data processing unit; and a nonvolatile memory unit which stores control information involved with data processing. The image processing device has a power-saving operation mode, in which no power source is supplied to the data processing unit, and a normal operation mode, in which a power source is supplied to the data processing unit. In the power-saving operation mode, the communication-processing section causes the data processing unit to transition to the normal operation mode when detecting a processing request for data processing. Then, the data processing unit acquires the control information from the nonvolatile memory unit according to the detected processing request, and executes data processing based on the control information.

The effect achieved by the representative embodiment of the invention is as follows in brief.

The image processing device has a power saving mode which enables the reduction of power consumption in the standby condition, and which enables high-speed recovery from the power-saving mode to the normal condition.

### BRIEF DESCRIPTION OF THE DRAWINGS

FIG. 1 is a diagram showing an image processing device according to the first embodiment of the invention;

FIG. 2 is a diagram showing an example of the software configuration of a stream-data-processing base software program;

FIG. 3 is a diagram showing an example of transition of condition of the image processing device involved in power supply;

FIG. 4 is a diagram showing an example of the flow of processing at transition from the normal operation mode to the power-saving operation mode;

FIG. 5 is a diagram showing an example of the flow of processing at time of transition from the power-saving operation mode to the normal operation mode; and

FIG. 6 is a diagram showing an example of a chain of information corresponding to each of events.

### DETAILED DESCRIPTION

1. Summary of the embodiments

The preferred embodiments of the invention herein disclosed will be outlined first. Here, the reference numerals for reference to the drawings, which are accompanied with paired round brackets, only exemplify what the concepts of members or components referred to by the numerals contain.

[1] (Image Processing Device which Reads out a Chain of Information in Response to an Event at Time of Recovery from the Power-Saving Operation)

An image processing device (11, 29) according to the representative embodiment of the invention has: a data processing unit (12) operable to execute data processing of input stream data; a power-source-control unit (21) operable to control power supply to the data processing unit; and a nonvolatile memory unit (24) which has a nonvolatile memory region (31, 32), and which control information (chain of information) used for data processing is stored in each time of data processing. Further, the image processing device has a communication-processing section (20) which exchanges data through a network (26, 28), accepts input of a processing request for data processing from the data processing unit, and controls the data processing unit and the power-source-control unit. The power-source-control unit controls a normal operation mode (52) in which the data processing unit is supplied with power, and a power-saving operation mode (53) in which the data processing unit is supplied with no power. The communication-processing section has an event-detection unit (23) operable to detect the processing request, and to control the power-source-control unit based on a result of detection. In the power-saving operation mode, the event-detection unit controls the power-source-control unit so that the data processing unit transitions to the normal operation mode on condition that the event-detection unit detects the processing request. The data processing unit acquires control information (chain of information) for execution of data processing corresponding to the detected processing request, from the nonvolatile memory unit, and executes data processing based on the control information. According to the arrangement like this, the data processing unit can acquire the control information corresponding to the processing request from the nonvolatile memory unit at time of recovery from the power-saving operation mode to the normal operation mode, and therefore, the need for newly producing the control information is eliminated. As a result, it becomes possible to shorten the period of time between the recovery of the data processing unit to the normal operation mode and the execution of data processing corresponding to the processing request.

[2] (Nonvolatile Memory in the Communication-Processing Section)

In regard to the image processing device as described in [1], the nonvolatile memory unit is provided in the communication-processing section. According to the arrangement like this, an access can be made to the control information for execution of data processing even in the power-saving operation mode.

[3] (Chain of Information Accessible via Network)

In regard to the image processing device as described in [1] or [2], the nonvolatile memory region is rewritable, and the control information for execution of data processing is accessible through the network. According to the arrangement like this, the data processing device can exchange and update the control information for execution of data processing through a network even in the power-saving operation mode.

[4] (Chain of Information—Including Sequence and Resource Data)

In regard to the image processing device as described in any one of [1] to [3], the control information for execution of data processing (chain of information) is information which specifies a combination of a software program (43, 431 to 435) executed to realize a certain function and a resource (17) utilized by the software program in order of execution. According to the arrangement like this, it becomes easier to correct a software program which actually conducts data processing, and to correct a sequence of the processing.

[5] (Basic Configuration of Software for Data Processing)

The image processing device as described in [4] further has a program memory (17) including: an application program (40) which issues a command according to the processing request; a chain processing program (42) for reading out the control information from the nonvolatile memory unit according to the command; and the software program (43, 43_1 to 43_5) specified by the control information. According to the arrangement like this, a software program used to execute a process adapted to an application is constructed based on a software program to realize the certain function, and information specified in order of execution of the program. Therefore, it becomes easier to correct of the software program and to change the software program to adapt to a hardware function that the image processing device has.

[6] (Types of Detected events)

In regard to the image processing device as described in any one of [1] to [5], the image processing device further has: a user-control unit (30) which issues the processing request according to data input from thereoutside; and a timer unit (22) which the communication-processing section sets time information on, and which issues the processing request at a time depending on the time information. The event-detection unit detects the processing request from the user-control unit, the processing request input through the network, and the processing request from the timer unit.

[7] (Types of Chain of Information)

In regard to the image processing device as described in any one of [1] to [6], the nonvolatile memory unit stores the control information for displaying data on an external display device, the control information for data exchange through a network, and the control information for storing data in a memory device. The types of chain of information are as described in the list 60 of FIG. 6.

[8] (Evacuation of Chain of Information at Transition to the Power-Saving Mode)

In regard to the image processing device as described in any one of [1] to [7], the nonvolatile memory unit has a first memory region (31) and a second memory region (32), in which the control information have been stored in advance. The data processing unit stores, in the second memory region, the control information involved with data processing which has been in execution until just before transition to the power-saving operation mode at time of the transition. According to the arrangement like this, it becomes possible to return to the data processing which has been in execution until just before the transition to the power-saving operation mode.

[9] (Select of Chain of Information at Time of Return to the Normal Operation Mode)

In regard to the image processing device as described in any one of [1] to [8], at time of transition from the power-saving operation mode to the normal operation mode, the data processing unit acquires one of the control information stored in the first memory region, and the control information stored in the second memory region, according to the detected processing request. According to the arrangement like this, it becomes possible to select whether or not to continue the execution of the processing which was in execution until just before the transition to the power-saving operation mode.

[10] (Creation of a Signal for Transition to the Power-Saving Mode by the Data Processing Unit)

In regard to the image processing device as described in any one of [1] to [9], the data processing unit further creates a signal for transition to the power-saving operation mode, and the communication-processing section accepts input of the created signal, and controls the power-source-control unit so that the data processing unit transitions to the power-saving operation mode. According to the arrangement like this, it becomes possible for the data processing unit to perform the control to transition to the power-saving operation mode by itself.

[11] (Creation of a Signal for Transition to the Power-Saving Mode with No Data Processing Executed for a Fixed Period of Time)

In regard to the image processing device as described in [10], the data processing unit creates a signal for transition to the power-saving operation mode in case that no data processing is executed for a predetermined period of time.

[12] (Creation of a Signal for Transition to the Power-Saving Mode with No User Direction for a Fixed Period of Time)

In regard to the image processing device as described in [10], the data processing unit creates a signal for transition to the power-saving operation mode in case that no processing request is issued by the user-control unit for a predetermined period of time.

[13] (Stop of Power Supply to the Timer Unit) In regard to the image processing device as described in [6], the power-source-control unit stops power supply to the timer unit in case that no time information is set on the timer unit, at time of causing a transition to the power-saving operation mode. According to the arrangement like this, it becomes possible to further reduce the power consumption in the power-saving operation mode.

[14] (Semiconductor Device)

In regard to the image processing device as described in any one of [1] to [13], the data processing unit (12) is formed on a semiconductor substrate.

### 2. Further Detailed Description of the Embodiments

The embodiments will be described further in detail.

### First Embodiment

### Outline of the Image Processing Device

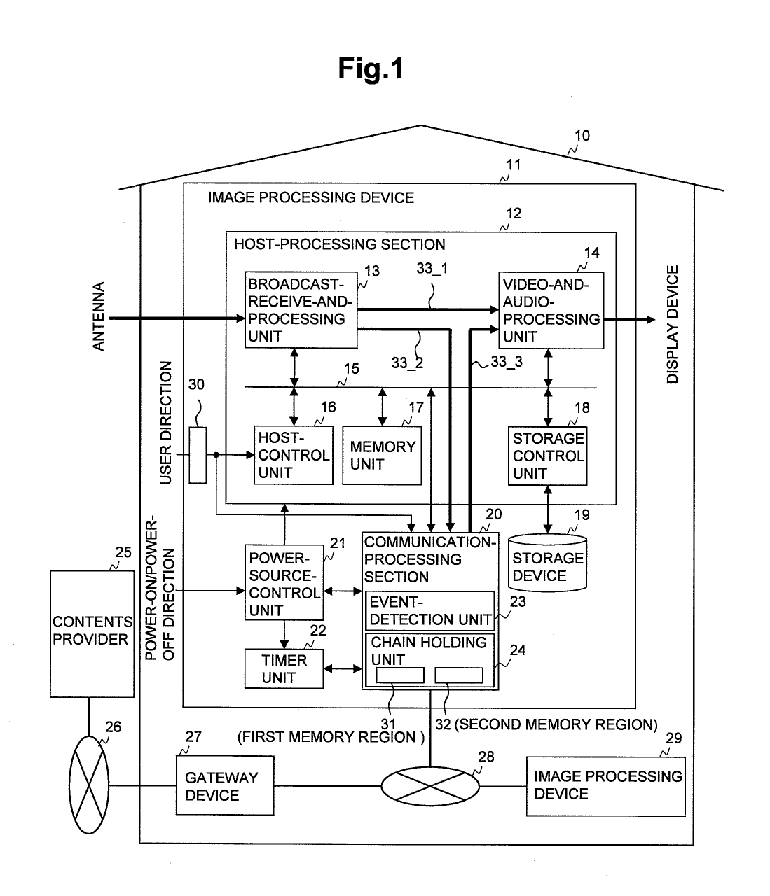

FIG. 1 shows an image processing device according to an embodiment of the invention.

In the description below, the image processing device 11 placed in a house 10 is taken as an example.

The image processing device 11 performs a processing for watching broadcast contents received through an antenna in real time while using a display device such as a monitor, and a processing for recording contents received on an as-needed basis in a storage device 19 such as HDD (Hard Disk Drive). Also, the image processing device 11 performs a processing for delivering broadcast contents, which have been recorded in the storage device 19, to another image processing device 29 through a home network 28 placed in the house. Further, the image processing device 11 also receives IP broadcast contents through the Internet 26 and a gateway device 27 from a server 25 of a contents provider, and executes various kinds of processing, such as processing for real-time watching and recording as performed on the broadcast contents, which are also hereinafter referred to as “media processing”. Examples of the products of the image processing device 11 include a flat-screen TV, STB and IPTV terminal device.

The image processing device 11 has: a host-processing section 12; a communication-processing section 20; a power-source-control unit 21; a timer unit 22; a user-control unit 30; and the storage device 19.

The host-processing section 12 executes a data processing for actually conducting media processing, such as recording and reproduction of contents according to a processing request from the user-control unit 30 which issues the processing request in response to a direction entered by a user. The details of the host-processing section 12 including its structure will be described later.

The user-control unit 30 accepts a user direction, and then provides a processing request according to the direction to the host-processing section 12 and communication-processing section 20. The user-control unit 30 may be e.g. a device which accepts a signal from a remote controller, or a device which accepts a manipulation by the user through a button or the like.

The communication-processing section 20 provides a connection means for communicating through the home network 28 with an other image processing device 29 which is placed in the same house 10 and is identical in function with the image processing device 11. Also, the communication-processing section 20 provides a connection means for communicating through the Internet 26 with a contents provider which offers contents such as video and music data. Specifically, the communication-processing section 20 processes basic communication protocols, such as TCP (RFC 793), UDP (RFC 768) and IP (RFC 791), and performs an application protocol processing on a combination of basic communication protocols, e.g. UPnP (Universal Plug And Play) . The application protocol processing is e.g. a processing which enables the media processing on data acquired from the other image processing device 29, and the sharing of contents data with the image processing device 29. During these types of protocol processing, the communication-processing section 20 also conducts a series of packet-exchange processing, including the analysis of a communication packet, and the creation and sending of a response packet. For instance, in the case of making an attempt to watch IP (Internet Protocol) broadcast contents provided by the contents provider 25, the communication-processing section 20 first conducts a preliminary processing such as a requisite authentication between the image processing device 11 and the contents provider 25. After that, the communication-processing section 20 extracts stream data of a video image, audio and the like included in packet data received from the contents provider 25, transforms the stream data to have a predetermined size and to fit into a predetermined format, and then transfers the resultant data to a video-and-audio-processing unit 14 through the stream data line 33_3. Further, as another example, in the case of making an attempt to deliver contents data recorded in the storage device 19 to the image processing device 29, the communication-processing section 20 acquires contents data from the storage device 19 through a bus 15 and adds header a header and other information to the acquired contents data, on receipt of a video-distribution request from the image processing device 29. Then, the communication-processing section 20 transforms the resultant contents data to fit into a predetermined packet format and to have a predetermined data size using a buffer (not shown) in the communication-processing section 20, and transmits the data to the image processing device 29 through the home network 28.

Further, the communication-processing section 20 controls the power-source-control unit 21, thereby to control the switching of the image processing device between the normal operation mode and power-saving operation mode. This will be described later.

The power-source-control unit 21 controls the power supplies to the host-processing section 12, the communication-processing section 20, the timer unit 22, the storage device 19, and the like according to a control signal from the communication-processing section 20, or power-on and power-off directions from the outside.

The timer unit 22 counts time based on the setting by the communication-processing section 20. The setting for counting time is made based on a count-of-time start request issued by the host-processing section 12 and provided to the timer unit 22 through the communication-processing section 20. For instance, the timer unit 22 is set in response to a request for e.g. reservation of video recording from the host-processing section 12, and starts the time counting.

The storage device 19 is composed of HDD or a nonvolatile memory, and used to store OS (Operating System), stream data involved in recording, etc.

### (Details of the Structure of Host Processing Unit 12)

Next, the host-processing section 12 will be described in detail.

Although no special restriction is intended, the host-processing section 12 is composed of a semiconductor integrated circuit formed on a semiconductor substrate, such as a bulk of monocrystalline silicon, by a known CMOS ICs' manufacturing technique. The host-processing section 12 is materialized as a structure of SoC (System On Chip), for example. Now, it is noted that the host-processing section 12 may be formed in one IC including the memory unit 17, or the memory unit 17 may be formed in a chip separate from the host-processing section 12.

The host-processing section 12 has: a broadcast-receive-and-processing unit 13; a video-and-audio-processing unit 14; a host-control unit 16, memory unit 17; and a storage-control unit 18. The circuit blocks of the host-processing section 12, and the communication-processing section 20 are all connected with the bus 15, which make a request for processing to each other, or return a response to the request. The broadcast-receive-and-processing unit 13, the video-and-audio-processing unit 14 and the communication-processing section 20 are connected to one another through stream data lines 33_1 to 33_3, which are dedicated lines for exchange of stream data. Now, it is noted that transmission of stream data may be performed through the bus 15. Whether to use the bus 15 depends on the detail of the media processing.

The broadcast-receive-and-processing unit 13 includes: a demodulator; a descrambler; and a demultiplexer, which demodulates an analog signal received through the antenna and converts the demodulated signal into a digital signal, and then performs a processing for descramble. Further, the broadcast-receive-and-processing unit 13 extracts stream data involved in predetermined program information, and transmits the extracted stream data to the communication-processing section 20, and the video-and-audio-processing unit 14 through the stream data lines 33_1 and 33_2, according to a direction from the host-control unit 16.

The video-and-audio-processing unit 14 is a decoder which supports various types of compression systems, and which accepts stream data output by the broadcast-receive-and-processing unit 13 and the communication-processing section 20, decodes the stream data according to a predetermined compression system, and then outputs the stream data in the form of analog or digital signals to the external display device.

The memory unit 17 includes a volatile memory such as DRAM (Dynamic Random Access Memory) or a nonvolatile memory, such as a semiconductor flash memory, in which a stream-data-processing base software program 44, which is to be described later, an application software program 40 and various kinds of data created in the course of processing by these programs are stored.

The storage-control unit 18 is an interface for controlling accesses to the storage device 19, which includes accesses for write to and read from the storage device 19.

The host-control unit 16 is a processor core which issues a processing request to the functioning unit, and accepts a response to the processing request, and which has a general control of the image processing device 11. The host-control unit 16 has a general-purpose processor (CPU), and an interface unit which supports the CPU and fits to the bus 15.

In addition, the host-control unit 16 conducts various kinds of media processing based on a stream-data-processing base software program—a program for execution of media processing.

### (Configuration of the Stream-Data-Processing Base Software Program)

Here, the media processing by the host-control unit 16 will be described in detail.

The image processing device 11 handles mainly stream data which are series of successive data, such as video and music contents. Therefore, the image processing device 11 needs to conduct complicated and sophisticated stream data processing, including the management of a memory region to use, the control of the timing of processing, and the control of the order of processing. Therefore, the image processing device 11 has a stream-data-processing base software program as a middleware in between application software and hardware, which provides functions of performing various kinds of media processing, e.g. processing for the watching, recording and reproduction of broadcast contents by a user, and network distribution of broadcast contents.

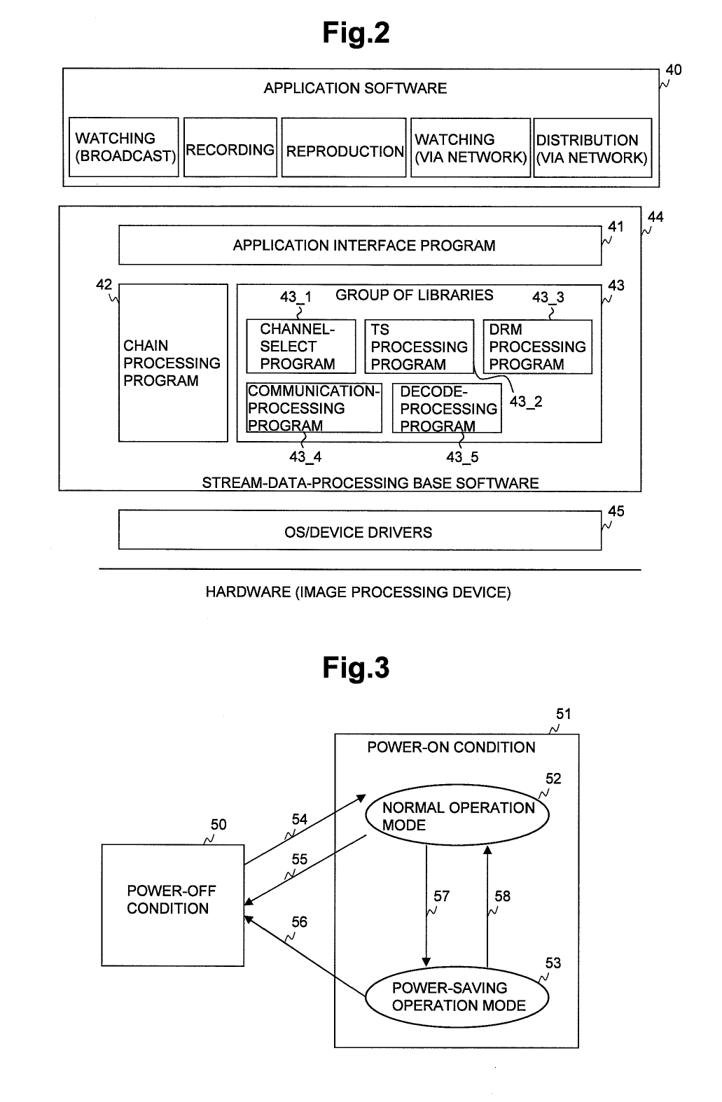

FIG. 2 shows an example of the software configuration of the stream-data-processing base software program.

As shown in FIG. 2, the stream-data-processing base software program 44 is arranged between an application software program 40 which issues a command to cause the image processing device 11 to execute various kinds of media processing, e.g. processing for the watching, recording and reproduction of broadcast contents by a user, and OS (Operating System)/device driver 45. These software programs are stored in the storage device 19 or another nonvolatile memory device (not shown), and in activation of the host-processing section 12, the software programs are read into the memory unit 17 as required.

The stream-data-processing base software program 44 executes various kinds of media processing according to a command that the application software program 40 issues . The stream-data-processing base software program 44 has: an application interface program 41 which provides an overall control interface for the application software program 40; and a library group 43 consisting of programs (hereinafter referred to as “libraries”) for controlling individual hardware functions. In the library group 43, software programs, e.g. a channel-select program 43_1, a TS (Transport Stream) processing program 43_2, a DRM (Digital Rights Management) processing program 43_3, a communication-processing program 43_4 for utilizing a network protocol stack, and a decode-processing program 43_5 are stored as the libraries. For instance, the DRM processing program 43_3 is a program for performing a processing of controlling the broadcast-receive-and-processing unit 13 to make the broadcast-receive-and-processing unit 13 descramble stream data, and the channel-select program 43_1 is a program for conducting a processing of controlling the broadcast-receive-and-processing unit 13 to select packet data to receive.

Also, the stream-data-processing base software program includes a chain processing program 42. The chain processing program 42 manages the creation, acquisition and discard of chain of information and the like, which will be described later, and controls, based on the chain of information, the start and stop of processing by the libraries, thereby controlling the execution of media processing.

### (Detail of Chain of Information)

Here, the chain of information will be described in detail.

The chain of information is an assemblage of pieces of information including: information which describes the flow of a series of processing, concatenating the libraries necessary for media processing; and information which specifies a memory region used in processing by the library. The chain of information is prepared for each media processing, and for example, a chain of information for watching broadcast contents, a chain of information for video recording, and a chain of information for network distribution are prepared. For instance, in the chain of information for watching broadcast contents, the programs such as the channel-select program 43_1, the DRM processing program 43_3, and the decode-processing program 43_5 are selected as libraries necessary for execution of processing for displaying, on an external display device, video data received by selecting a specified channel, and the processing procedure for executing the libraries is described in the chain of information. Further, information including the start address and address range of a memory region used in processing by each library is also described therein.

The chain of information is stored in a chain-holding unit 24 provided in the communication-processing section 20 for each media processing. The chain-holding unit 24 is composed of a memory device having a rewritable nonvolatile memory region as e.g. a flash memory includes, which has first and second memory regions 31 and 32. The first memory region 31 is a region to store a chain of initial information prepared in advance. For example, various kinds of chain of information are recorded in the first memory region 31 in the manufacturing stage of the product. The second memory region 32 is a region to store a chain of information other than the chain of initial information. For instance, in case that a new command is entered to cause an interrupt during the time when the chain processing program 42 is executing the media processing, the host-control unit 16 stores the chain of information involved with the processing in execution in the second memory region 32. Also, in case that the image processing device 11 goes into the power-saving operation mode, which is to be described later, the host-control unit 16 stores, in the second memory region 32, the chain of information involved with the media processing which has been in execution until just before the transition for the purpose of evacuation thereof.

The other image processing device 29 and the contents provider 25 can access the chain of information stored in the chain-holding unit 24 through the home network 28 or the Internet 26, or both of them. The chain of information stored in the chain-holding unit 24 can be corrected and updated by version upgrade or the like through a network on an as-needed basis. The chain-holding unit 24 remains supplied with a power source even in the power-saving operation mode to be described later because it is placed in the communication-processing section 20. Therefore, even in the condition where the image processing device 11 is working while saving power, the chain-holding unit 24 can be accessed through the network.

Now, the flow of the media processing by the host-control unit 16 using the chain of information will be described below.

For instance, when a processing request from the user is input to the host-control unit 16 through the user-control unit 30, the host-processing unit 16 runs the application software program 40, which has been read into the memory unit 17 in advance, thereby to create a command corresponding to the processing request. Subsequently, the host-processing unit 16 executes the application interface program 41 in the stream-data-processing base software program 44, which has been read into the memory unit 17 in advance, thereby to decode the created command. Then, the host-processing unit 16 runs the chain processing program 42 based on the decoded command, and thereafter confides the execution of the steps of the media processing to the chain processing program 42. The chain processing program 42 reads out a chain of information from the chain-holding unit 24 according to the command provided thereto, and stores the chain of information in the memory unit 17. Then, the chain processing program 42 brings the media processing into execution based on the read chain of information. For instance, in the case where the user has made a processing request for watching of broadcast contents, the chain processing program 42 acquires a chain of information involved with the media processing for watching of broadcast contents from the chain-holding unit 24, and controls, based on the chain of information, the activation and stop of libraries of the library group 43, and another operation thereof. Specifically, the chain processing program 42 activates the channel-select program 43_1 and makes the channel-select program select a channel to receive. After that, the chain processing program 42 activates the DRM processing program 43_3 and makes the DRM processing program descramble receive data associated with the selected channel. As described above, the chain processing program 42 performs control for activating and stopping the libraries in turn based on the chain of information.

According to the method as described above, the host-control unit 16 uses the stream-data-processing base software program 44 to execute the media processing, in which the chain processing program 42 acquires a chain of information from the chain-holding unit 24. Therefore, the need for the host-control unit 16 to prepare a chain of information according to a command issued in response to a processing request from a user each time the command is issued is eliminated. Hence, the way as described above can make shorter the time between the issue of a command and the actual start of the media processing in comparison to the way by which the host-control unit 16 prepares a chain of information and executes a media processing each time it receives a command.

### (Normal Operation Mode and Power-Saving Operation Mode)

Next, the operation modes of the image processing device associated with power supply will be described with reference to FIG. 3.

FIG. 3 is a diagram showing an example of transition of condition of the image processing device 11 involved in power supply.

As shown in FIG. 3, the states that the image processing device 11 stays in are roughly classified into two conditions, namely a power-off condition 50, and a power-on condition 51. In the power-on condition 51, the image processing device 11 is in a normal operation mode 52 where all the components or parts of the image processing device 11 are being supplied with power and the media processing can be executed, or in a power-saving operation mode 53 where the power supply to the host-processing section 12 is kept stopped, whereas the image processing device 11 can still communicate with the image processing device 29, a network and the like.

Which of the operation modes involved with power supply, the image processing device 11 is placed in is controlled by the power-source-control unit 21. The power-source-control unit 21 transitions between the operation modes as follows.

Under the condition where the image processing device 11 is in the power-off condition 50, when accepting a power-on direction, the power-source-control unit 21 supplies the host-processing section 12, the communication-processing section 20 and the timer unit 22 with power source, and thus the image processing device 11 transitions to the normal operation mode 52 as indicated by the arrow 54. Further, under the condition where the image processing device 11 is in the normal operation mode 52, when accepting a direction involved with change in power from the communication-processing section 20, the power-source-control unit 21 stops the power supply to the host-processing section 12, and the image processing device 11 transitions to the power-saving operation mode 53 as indicated by the arrow 57. However, under the condition where the image processing device 11 is in the power-saving operation mode 53, when accepting a direction involved with change in power from the communication-processing section 20, the power-source-control unit 21 supplies the host-processing section 12 with power, and the image processing device 11 transitions to the normal operation mode 52 as indicated by the arrow 58. Further, under the condition where the image processing device 11 is in the normal operation mode 52 or the power-saving operation mode 53, when accepting a power-off direction, the power-source-control unit 21 stops power supply to the host-processing section 12, the communication-processing section 20 and the timer unit 22, and the image processing device 11 transitions to the power-off condition 50 as indicated by the arrows 55 and 56.

### (Operation Mode Control by the Event Detection Unit 23)

The transition between the normal operation mode 52 and the power-saving operation mode 53 will be described here.

The communication-processing section 20 has the chain-holding unit 24 and the event-detection unit 23, and the event-detection unit 23 controls the power-source-control unit 21, whereby the operation mode is switched between the normal operation mode 52 and the power-saving operation mode 53.

In the power-saving operation mode, when detecting a processing request for media processing or the like, hereinafter referred to as “Event”, the event-detection unit 23 controls the power-source-control unit 21 so that the power-source-control unit causes a transition to the normal operation mode. Specifically, the following are input to the event-detection unit 23: a signal showing the end of counting of time issued by the timer unit 22, hereinafter referred to as “Timer Event”; a processing request for the media processing, such as watching of contents and network distribution of contents, which the user inputs through the user-control unit 30, hereinafter referred to as “User Event”; and a video-distribution request issued by the other image processing device 29 or the contents provider 25, hereinafter referred to as “Remote Event”. Then, the event-detection unit 23 detects the Timer Event, User Event and Remote Event. After having detected the events, the event-detection unit 23 issues the power-source-control unit 21 with a power-changing direction for change to the power for the normal operation mode.

Further, on receipt of a signal for directing a transition to the power-saving operation mode from the host-processing section 12 in the normal operation mode, the event-detection unit 23 controls the power-source-control unit so that the power-source-control unit causes a transition to the power-saving operation mode.

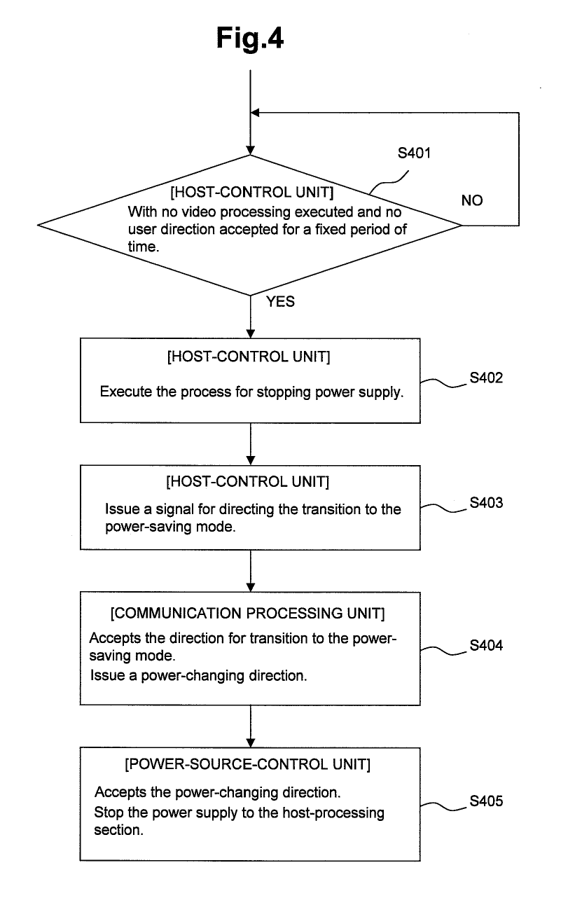

Now, the flow of processing in the image processing device 11 at transition from the normal operation mode to the power-saving operation mode will be described in detail with reference to FIG. 4.

FIG. 4 is a diagram showing an example of the flow of processing at transition from the normal operation mode to the power-saving operation mode.

In the normal operation mode, the host-control unit 16 monitors the progress of the media processing, and a user direction accepted (S401) . The monitoring is conducted using e.g. a device operable to measure progress of time (not shown) such as a watchdog timer in the host-control unit 16, which counts time during which no media processing is executed, and time during which a direction from a user is unaccepted. Further, on condition that no media processing is executed for a fixed period of time, and no user direction is accepted, the host-control unit 16 executes a processing of stopping the power source supply in order to bring the image processing device 11 to the power-saving operation mode (S402). Specifically, the host-control unit 16 evacuates, to the second memory region 32 in the chain-holding unit 24, the chain of information involved with the media processing was executed until just before the transition. In addition, the host-control unit 16 evacuates other data stored in the memory unit 17 to a nonvolatile memory device, such as the storage device 19, or performs another comparable action. Then, after completion of the processing of stopping the power supply, the host-control unit 16 issues the communication-processing section 20 with a signal for directing a transition to the power-saving operation mode through the bus 15 (S403) . On receipt of the signal for directing the transition, the communication-processing section 20 provides the power-source-control unit 21 with a power-changing direction for change to the power-saving operation mode (S404) . At this point of time, if no setting for measuring time is made on the timer unit 22, the communication-processing section 20 directs the power-source-control unit 21 to stop the power supply to the timer unit 22 as well as providing a power-changing direction for change to the power-saving operation mode. Then, the power-source-control unit 21, which has accepted the power-changing direction, stops the power supply to the host-processing section 12 and the timer unit 22 to cause a transition to the power-saving operation mode (S405). According to the arrangement as described above, it becomes possible to cut the power consumed by the image processing device 11 on standby. This is because the image processing device 11 stops the power supply to the host-processing section 12 and the timer unit 22 on an as-needed basis. In addition, even in the power-saving operation mode, the image processing device 11 can communicate with other image processing device 29 or the contents provider 25 through the home network 28 and the Internet 26 because the communication-processing section 20 remains supplied with power source.

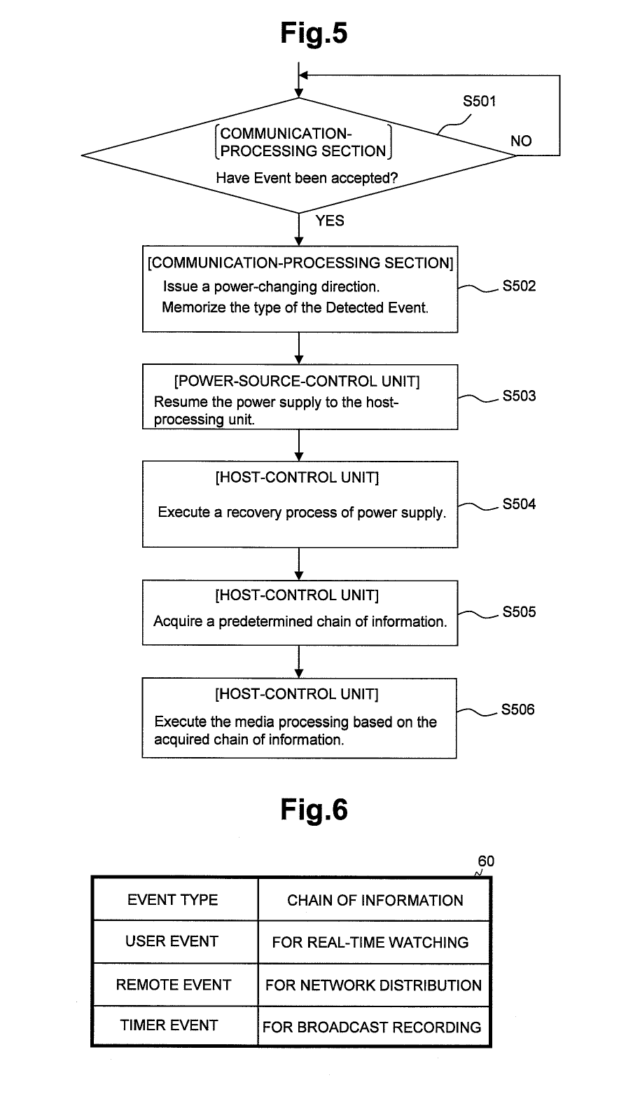

Next, the flow of processing in the image processing device 11 at time of transition from the power-saving operation mode to the normal operation mode will be described in detail with reference to FIG. 5.

FIG. 5 is a diagram showing an example of the flow of processing at time of transition from the power-saving operation mode to the normal operation mode.

First, in the power-saving operation mode, the event-detection unit 23 of the communication-processing section 20 monitors whether or not the Timer Event, User Event and Remote Event have been issued (S501). Then, when detecting even any one of the Events, the event-detection unit 23 issues a power-changing direction to the power-source-control unit 21 and in parallel, stores a piece of information of the type of the detected Event in a register provided therein (S502). After having accepted the power-changing direction, the power-source-control unit 21 resumes the power supply to the host-processing section 12 and the timer unit 23, and causes a transition to the normal operation mode (S503). Then, in response to the resumption of power supply, the host-control unit 16 executes a process for recovery of the entire host-processing section 12 (S504). Specifically, the host-control unit 16 activates the other functional blocks in the host-processing section 12. In addition, the host-control unit 16 reads out a software program such as the stream-data-processing base software program 44 stored in the storage device 19 or other nonvolatile memory device, and stores the software program in the memory unit 17. In parallel with this, the host-control unit 16 stores, in the memory unit 17, the data and others which have been evacuated to the storage device 19 at transition to the power-saving operation mode as well.

Then, the host-control unit 16 accesses the event-detection unit 23, refers to the type of Event memorized in the register of the event-detection unit 23, and acquires the chain of information from the first memory region 31 or the second memory region 32 (S505). For instance, if the media processing for the detected event will be executed regardless of the media processing was executed until just before the transition to the power-saving operation mode, the host-control unit 16 acquires the chain of information corresponding to the type of Event memorized in the register from the first memory region 31.

FIG. 6 shows an example of chain of information corresponding to each of the events.

As shown by the reference numeral 60 of FIG. 6, the chain of information that the host-control unit 16 acquires has been set corresponding to the detected event in advance. For instance, in the case of User Event for requesting the start of watching, the host-control unit 16 acquires the chain of information for real-time watching. In the case of Remote Event, the host-control unit 16 acquires the chain of information for network distribution. Further, in the case of Timer Event associated with broadcast recording, the host-control unit 16 acquires the chain of information for broadcast recording.

In Step S505, after having acquired the chain of information, the host-control unit 16 executes the media processing according to the above-described method (S506).

According to the first embodiment of the invention, in the case where in the power-saving operation mode, the communication-processing section 20 detects one of the events and consequently the image processing device 11 is recovered to the normal operation mode, the host-control unit 16 acquires the chain of information corresponding to the detected event from the chain-holding unit 24 and then executes the media processing. Therefore, the time between the detection of Event and the execution of the media processing can be shortened, and thus the higher-speed recovery of the image processing device can be achieved. As a result, it becomes possible to curb the increase in the capacity of a buffer, which is used to temporarily store stream data in the period of time between the transition to the normal operation condition and the start of its processing.

While the embodiment of the invention made by the inventor has been described specifically, the invention is not limited to the embodiment. It should be obvious that various changes and modifications may be made with the scope of the subject matter thereof.

While the example where the host-control unit 16 acquires the chain of information from the first memory region 31 in Step S505 shown in FIG. 5 in the course of the transition of the image processing device 11 from the power-saving operation mode to the normal operation mode, has been described, the invention is not limited to the example. The image processing device may be arranged so that the host-control unit 16 acquires the chain of information from the second memory region 32, instead. For example, the host-control unit 16 may acquire a chain of information, which has been evacuated from the second memory region 32 at transition to the power-saving operation mode regardless of the type of Event memorized by the register. According to the arrangement like this, the media processing which has been in execution until just before the transition to the power-saving operation mode can be executed without interruption regardless of the event detected at recovery to the normal operation mode. Further, while in the first embodiment, the host-control unit 16 reads out a software program, such as the stream-data-processing base software program 44 in Step S504 of FIG. 5 at transition from the power-saving operation mode to the normal operation mode, the invention is not so limited. The image processing device may be arranged so that the host-control unit 16 reads out a chain of information and then a required software program is read out according to the chain of information.

Still further, while the power supply to the host-processing section 12 is stopped concurrently with the power supply to the timer unit 22 in the power-saving operation mode, the invention is not so limited. The power supply to the timer unit 22 need not be stopped. The power supply to functioning units other than functioning units in charge of the execution of the operation for the transition to the normal operation mode, such as the communication-processing section 20 and the power-source-control unit 21 may be stopped.

While in the example described above, the host-control unit 16 monitors both the execution of the media processing and the acceptance of a user direction, and uses the result of the monitoring as a prerequisite condition to start the transition to the power-saving operation mode, the invention is not so limited. The image processing device may be arranged so that the host-control unit 16 monitors either the execution of the media processing or the acceptance of a user direction, and uses the result of the monitoring as a prerequisite condition to start the transition to the power-saving operation mode. Also, a user direction input through the user-control unit 30 or a control signal from the image processing device 29 or the contents provider 25 through the home network 28 can be used as a prerequisite condition to start the transition to the power-saving operation mode.

Incidentally, the user-control unit 30 may be placed on both the host-control unit 16 and the communication-processing section 20.

What is claimed is:

1. An image processing device comprising:
a data processing unit operable to execute data processing of input stream data;
a power-source-control unit operable to control power supply to the data processing unit;
a nonvolatile memory unit which has a nonvolatile memory region, and which control information used for data processing is stored in each time of data processing; and
a communication-processing section which exchanges data through a network, accepts input of a processing request for data processing from the data processing unit, and controls the data processing unit and the power-source-control unit,
wherein the power-source-control unit controls a normal operation mode in which the data processing unit is supplied with power, and a power-saving operation mode in which the data processing unit is supplied with no power,
the communication-processing section has an event-detection unit operable to detect the processing request, and to control the power-source-control unit based on a result of detection,
in the power-saving operation mode, the event-detection unit controls the power-source-control unit so that the data processing unit transitions to the normal operation mode on condition that the event-detection unit detects the processing request, and
the data processing unit acquires control information for execution of data processing corresponding to the detected processing request, from the nonvolatile memory unit, and executes data processing based on the control information.

2. The image processing device according to claim 1, wherein the nonvolatile memory unit is provided in the communication-processing section.

3. The image processing device according to claim 1, wherein the nonvolatile memory region is rewritable, and
the control information for execution of data processing can be accessed through the network.

4. The image processing device according to claim 1, wherein the control information for execution of data processing is information which specifies a combination of a software program executed to realize a certain function and a resource utilized by the software program in order of execution.

5. The image processing device according to claim 4, further comprising a program memory including: an application program which issues a command according to the processing request;
a chain processing program for reading out the control information from the nonvolatile memory unit according to the command; and
the software program specified by the control information.

6. The image processing device according to claim 1, further comprising:
a user-control unit which issues the processing request according to data input from thereoutside; and
a timer unit which the communication-processing section sets time information on, and which issues the processing request at a time depending on the time information,
wherein the event-detection unit detects the processing request from the user-control unit, the processing request input through the network, and the processing request from the timer unit.

7. The image processing device according to claim 1, wherein the nonvolatile memory unit stores the control information for displaying data on an external display device, the control information for data exchange through the network, and the control information for storing data in a memory device.

8. The image processing device according to claim 1, wherein the nonvolatile memory unit has a first memory region and a second memory region, in which the control information have been stored in advance, and
the data processing unit stores, in the second memory region, the control information involved with data processing which has been in execution until just before transition to the power-saving operation mode at time of the transition.

9. The image processing device according to claim 8, wherein at time of transition from the power-saving operation mode to the normal operation mode, the data processing unit acquires one of the control information stored in the first memory region, and the control information stored in the second memory region, according to the detected processing request.

10. The image processing device according to claim 1, wherein the data processing unit further creates a signal for transition to the power-saving operation mode, and
the communication-processing section accepts input of the created signal, and controls the power-source-control unit so that the data processing unit transitions to the power-saving operation mode.

11. The image processing device according to claim 10, wherein the data processing unit creates a signal for transition to the power-saving operation mode in case that no data processing is executed for a predetermined period of time.

12. The image processing device according to claim 10, wherein the data processing unit creates a signal for transition to the power-saving operation mode in case that no processing request is issued by the user-control unit for a predetermined period of time.

13. The image processing device according to claim 6, wherein the power-source-control unit stops power supply to the timer unit in case that no time information is set on the timer unit, at time of causing a transition to the power-saving operation mode.

14. The image processing device according to claim 1, wherein the data processing unit is formed on a semiconductor substrate.
